(19) United States
(12) Patent Application Publication
(10) Pub. No.: US 2006/0261601 A1
(43) Pub. Date: Nov. 23, 2006

(54) Door lock device for vehicle

(75) Inventors: Kimito Shimizu, Anjo-shi (JP); Akira Tani, Anjo-shi (JP); Yasutaka Shinoda, Anjo-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/435,983

(22) Filed: May 18, 2006

(30) Foreign Application Priority Data
May 18, 2005 (JP) 2005-145513

(51) Int. Cl. E05C 3/06

(52) U.S. Cl. 292/216

(57) ABSTRACT

A door lock device for a vehicle includes a striker, a first member including a groove portion for receiving the striker, a latch engaging with the striker so as to retain the door relative to the vehicle body, a release member operated so as to release an engagement between the latch and the striker, a second member connected to the first member for holding the latch and the release member, a motor for generating a driving force so as to operate the release member, a transmission mechanism for transmitting the driving force generated by the motor to the release member, and a case for receiving the motor and the transmission mechanism. The case includes the second member and a third member connected to the second member and accommodating therein the motor and the transmission mechanism. The second member is sandwiched between the first member and the third member.

### CROSS REFERENCE TO RELATED APPLICATIONS

This application is based on and claims priority under 35 U.S.C. §119 to Japanese Patent Application No. 2005-145513, filed on May 18, 2005, the entire content of which is incorporated herein by reference.

### FIELD OF THE INVENTION

This invention generally relates to a door lock device for a vehicle.

### BACKGROUND

A known door lock device is disclosed in US2001-5078A1. The door lock device disclosed includes a striker formed on a vehicle body, a latch formed on the door and engaging with the striker so as to retain the door relative to the vehicle body, a release member operated so as to release an engagement between the latch and the striker, a motor for generating a driving force used for operating the release member, and a transmission member for transmitting the driving force generated by the motor to the release member. The latch and the release member are received in a first case while the motor and the transmission member are received in a second case. That is, the first and second cases are formed separately and between which a plate is arranged. The first and second cases are respectively formed on one side and the other side of the plate that is bent so as to form a V-shape.

According to the aforementioned door lock device, a lock mechanism constituted by the latch and the release member, and an actuator connected to the lock mechanism and constituted by the motor and the transmission member are formed separately. Thus, the lock mechanism and the actuator individually formed are connected to each other by means of the plate bent into a V-shape. Accordingly, the size of the entire device is large, which may be a disadvantage for the device to be installed in a confined space of the door.

Thus, a need exists for a door lock device that can be installed in a confined space of a door.

### SUMMARY OF THE INVENTION

According to an aspect of the present invention, a door lock device for a vehicle includes a striker formed on either a vehicle body or a door, a first member including a groove portion for receiving the striker and being formed on either the door or the vehicle body, a latch engaging with the striker so as to retain the door relative to the vehicle body and being rotatably supported by the first member, a release member operated so as to release an engagement between the latch and the striker, a second member connected to the first member for holding the latch and the release member, a motor for generating a driving force so as to operate the release member, a transmission mechanism for transmitting the driving force generated by the motor to the release member, and a case for receiving the motor and the transmission mechanism. The case includes the second member and a third member connected to the second member and accommodating therein the motor and the transmission mechanism. The second member is sandwiched between the first member and the third member.

### BRIEF DESCRIPTION OF THE DRAWINGS

The foregoing and additional features and characteristics of the present invention will become more apparent from the following detailed description considered with reference to the accompanying drawings, wherein:

FIG. 1 is a perspective view of a rear portion of a vehicle equipped with a door lock device according to an embodiment of the present invention;

FIG. 2 is a schematic view of the door lock device and a peripheral structure thereof;

FIG. 3 is a front view of the door lock device viewed from an arrow B direction in FIG. 2;

FIG. 4 is a top view of the door lock device viewed from an arrow C direction in FIG. 3;

FIG. 5 is an exploded perspective view of a lock mechanism of the door lock device;

FIG. 6 is a view showing an engagement state between a latch and a striker, along with a pawl;

FIGS. 7A, 7B, and 7C are views each showing a state in which a first end portion of a supporting shaft is riveted to a base;

FIG. 8 is an exploded perspective view of a release mechanism of the door lock device;

FIG. 9 is a view showing a structure of a sector gear;

FIG. 10 is a view showing a structure of an engaging portion of the sector gear;

FIG. 11 is a view of the release mechanism when viewed from a lower side in FIG. 8;

FIG. 12 is a view of a sub-base when viewed from an upper side in FIG. 8;

FIG. 13 is a view showing a structure of a guide face of the sub-base;

FIG. 14 is a view showing a structure of a connecting portion of a cover;

FIG. 15 is a view showing a structure of a connector of the cover;

FIGS. 16A, 16B, 16C, and 16D are views showing a series of assembly operations of the door lock device;

FIGS. 17A, 17B, and 17C are views showing a method of connecting an engaging portion of the sector gear to a lever supporting bore of the cover;

FIGS. 18A, 18B and 18C are views showing a method of connecting a connecting portion of the cover to the sub-base of the lock mechanism;

FIGS. 19A, 19B, and 19C are views showing a method of fitting a terminal of a detection switch to a connector of the sector gear;

FIG. 20 is a view showing each movement of the sector gear and the lift lever when the door lock device is operated; and

FIG. 21 is a view showing a positional relationship between the sector gear and the lift lever.

### DETAILED DESCRIPTION

An embodiment of the present invention is explained with reference to the attached drawings.

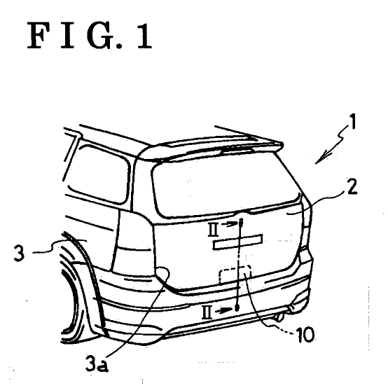

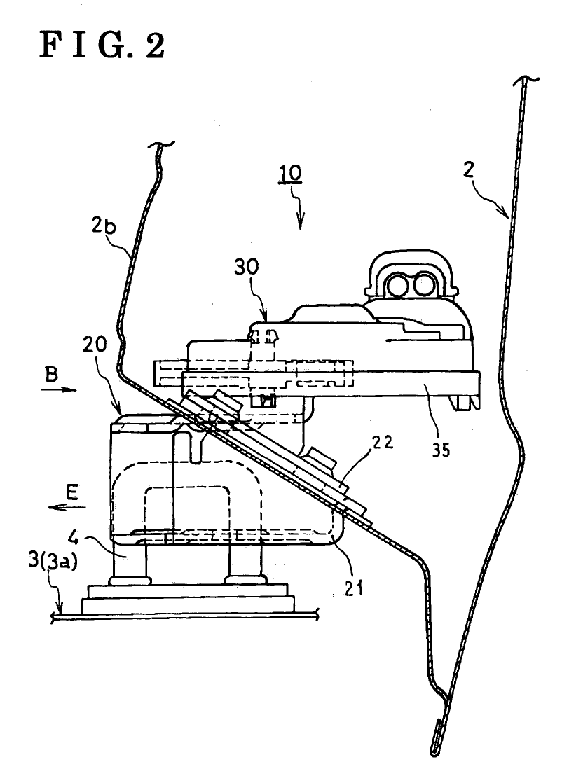

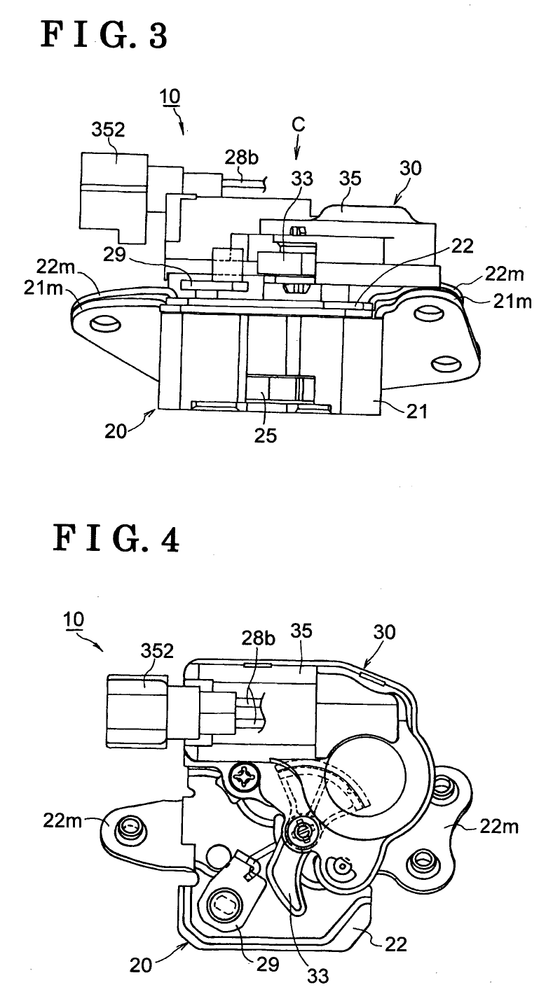

FIG. 1 is a perspective view showing a rear portion of a vehicle 1 equipped with a door lock device 10 (vehicle door lock device) according to the present embodiment. FIG. 2 is a schematic view showing the door lock device 10 and a peripheral structure thereof (i.e. a cross-sectional view taken along the line II-II of FIG. 1). FIG. 3 is a front view of the door lock device 10 (i.e. an arrow view in B direction in FIG. 2). FIG. 4 is a top view of the door lock device 10 (i.e. an arrow view in C direction in FIG. 3).

As shown in FIG. 1, the rear portion of the vehicle 1 is equipped with a door 2. The door 2 is a backdoor having a known structure of opening or closing an opening portion 3a formed on a body 3, which serves as an example of a vehicle body, of the vehicle 1. The door lock device 10 is arranged on a lower portion of the door 2.

The door lock device 10 includes a lock mechanism 20 and a release mechanism 30. The release mechanism 30 is arranged, being placed onto the lock mechanism 20. The door lock device 10 is provided within the door 2 in such a manner that the door lock device 10 is secured to the door 2 by means of a fixing means such as a screw (not shown). The lock mechanism 20 of the door lock device 10 faces the outside of the door 2 through an opening (not shown) formed on an inside panel 2b of the door 2.

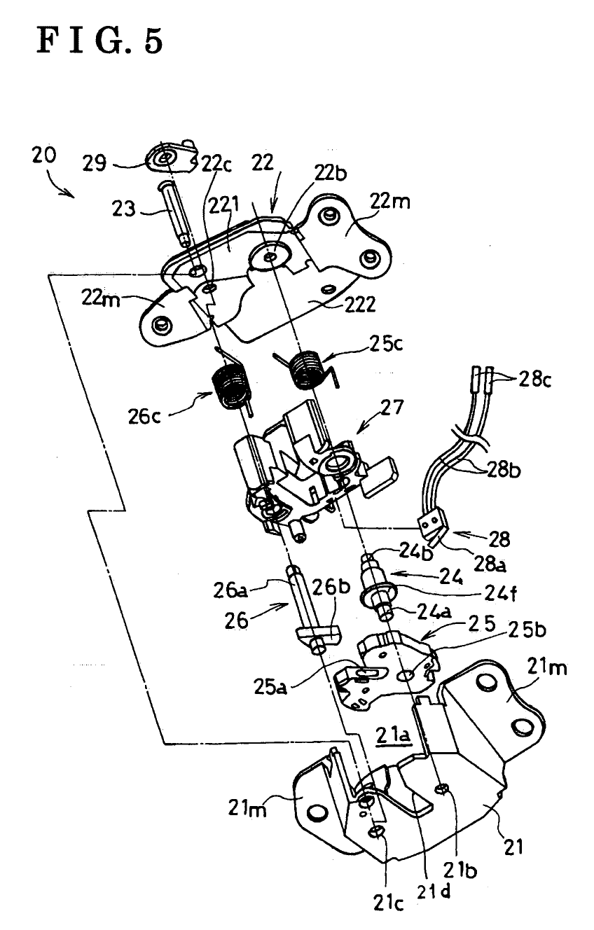

The lock mechanism 20 is explained with reference to FIG. 5, which is an exploded perspective view of the lock mechanism 20. The lock mechanism 20 is formed on the door 2 in the aforementioned manner, and is engageable with or disengageable from a striker 4 (see FIG. 2) secured to an edge of the opening portion 3a of the body 3.

The lock mechanism 20 includes a base 21 serving as an example of a first member, and a sub-base 22 serving as an example of a second member, both of which function as a structural base portion in the lock mechanism 20. The box-shaped base 21, which is made of metal, includes a receiving portion 21a having a concave shape and a groove portion 21d for receiving the striker 4. The plate-shaped sub-base 22, which is made of metal, includes a first portion 221 and a second portion 222.

The base 21 is connected to the first portion 221 of the sub-base 22 by means of a connecting pin 23. The connecting pin 23 is a metal rod having a head portion at one end and extending between the base 21 and the first portion 221 of the sub-base 22. Further, the connecting pin 23 is inserted into the first portion 221 of the sub-base 22 and then the base 21 in such a manner that the other end of the connecting pin 23 is positioned ahead when inserted. The other end of the connecting pin 23 that is inserted into the base 21 is riveted thereto. Accordingly, one end and the other end of the connecting pin 23 engage with the first portion 221 of the sub-base 22 and the base 21 respectively. The base 21 and the sub-base 22 are connected to each other so that the receiving portion 21a of the base 21 is covered by the first portion 221 of the sub-base 22. The base 21 and the sub-base 22 connected to each other are secured to the door 2 (see FIG. 2) through fitting portions 21m and 22m using a tightening member such as a screw (not shown).

The base 21 accommodates in the receiving portion 21a a supporting shaft 24, a latch 25, a pawl 26 that serves as an example of a release member, a resin body 27, and a detection switch 28.

The supporting shaft 24 made of metal extends within the receiving portion 21a of the base 21. A first end 24a of the supporting shaft 24 is inserted into a supporting bore 21b formed on the base 21 while a second end 24b of the supporting shaft 24 is inserted into a supporting bore 22b formed on the sub-base 22. A flange portion 24f is formed on the supporting shaft 24 between the first end 24a and the second end 24b. The first end 24a is inserted into the supporting bore 21b of the base 21, and then riveted and secured thereto. The details of riveting of the supporting shaft 24 to the base 21 are explained later.

The latch 25 is divided into two portions and rotatably supported by the supporting shaft 24. The latch 25 includes a notch portion 25a and a through-hole 25b. The notch portion 25a has a substantially U-shape and by means of which the latch 25 engages with the striker 4 (see FIG. 2). The through-hole 25b is a rotation center of the latch 25 and into which the first end 24a of the supporting shaft 24 is inserted. An inner diameter of the through-hole 25b is defined smaller than an outer diameter of the flange portion 24f. The latch 25 engages with one end of a torsion spring 25c. The other end of the torsion spring 25c engages with the block-shaped resin body 27. Accordingly, the latch 25 is biased to rotate in one direction relative to the supporting shaft 24.

The pawl 26 includes a shaft portion 26a having a round bar shape and an engaging portion 26b having a block shape. One end of the shaft portion 26a is inserted into a pawl bore 21c formed on the base 21 while the other end of the shaft portion 26a is inserted into a pawl bore 22c formed on the first portion 221 of the sub-base 22. The shaft portion 26a is rotatably supported by the base 21 and the first portion 221 of the sub-base 22. A lift lever 29 serving as the release member is secured to the other end of the shaft portion 26a that is inserted into the pawl bore 22c. The lift lever 29 is connected to a lever portion 33 of the release mechanism 30 (to be mentioned later). The engaging portion 26b is provided on one end of the shaft portion 26a so as to be formed as a unit therewith. The pawl 26 engages with the latch 25 by means of the engaging portion 26b. Further, the pawl 26 rotates as a unit with the lift lever 29. The pawl 26 engages with one end of a torsion spring 26c. The other end of the torsion spring 26c engages with the resin body 27. The pawl 26 is biased to rotate in one direction relative to the shaft portion 26a accordingly.

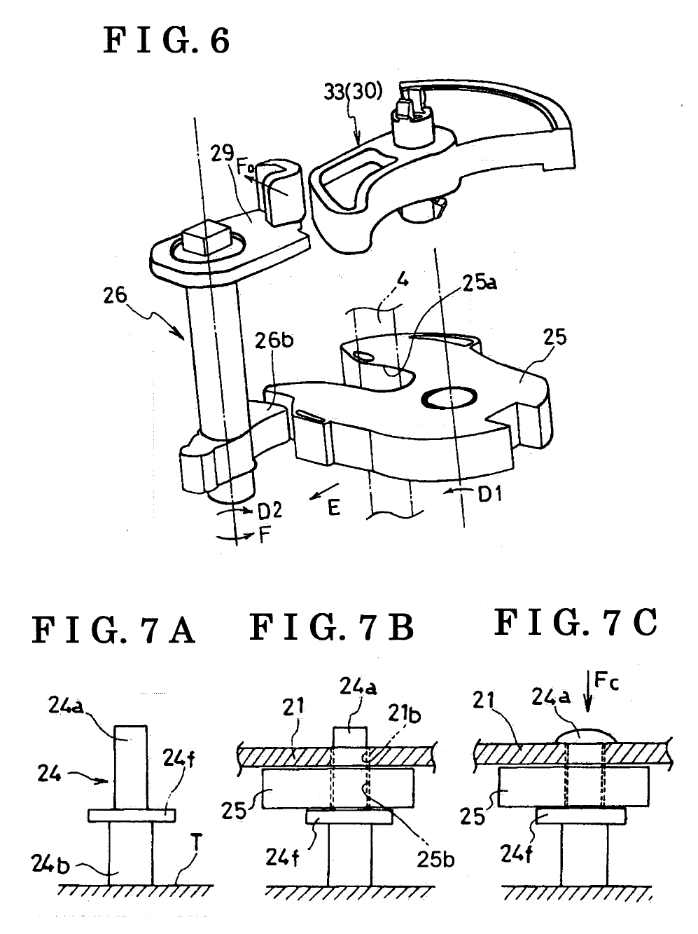

FIG. 6 is a view showing an engagement state between the latch 25 and the striker 4, along with the pawl 26. In FIG. 6, the latch 25 and the pawl 26 are biased in D1 and D2 directions by means of the torsion springs 25c and 26c (See FIG. 5) respectively.

In the cases where the door 2 is closed relative to the body 3 (i.e. closed state of the door), the striker 4 engages with the notch portion 25a of the latch 25 (i.e. full-latched state) as shown in FIG. 6. In such circumstances, the rotation of the latch 25 in the D1 direction is restricted by the engagement between the engaging portion 26b of the pawl 26 and the latch 25. The striker 4 is prohibited to move in E direction (see also FIG. 2) from the notch portion 25a of the latch 25. Thus, the lock mechanism 20 equipped with the latch 25 holds the striker 4 that is secured to the body 3, thereby causing the door 2 to be retained in a closed state relative to the body 3.

When the lift lever 29 secured to the pawl 26 receives a lever operation force Fo from the lever portion 33 of the release mechanism 30 in the full-latched state as shown in FIG. 6, the pawl 26 rotates in F direction against a biasing force of the torsion spring 26c (see FIG. 5). Then, the engaging portion 26b of the pawl 26 disengages from the latch 25. At this time, the latch 25 rotates in D1 direction by a biasing force of the torsion spring 25c so that the striker 4 is disengageable from the notch portion 25a of the latch 25 to move in E direction (i.e. unlatched state). In this state, the door 2 can be open relative to the body 3 (i.e. open state of the door). As shown in FIG. 5, the detection switch 28 is a known micro switch including an operation lever 28a, and retained by the resin body 27. The operation lever 28a of the detection switch 28 is engageable with or disengageable from the latch 25. One end of a signal line 28b is electrically connected to the detection switch 28. The signal line 28b of multi-purpose type is formed by a core wire that is made by twisting a copper wire, and an insulating covering material for coaxially covering the core wire. A metal terminal 28c is connected to the other end of the signal line 28b. The detection switch 28 is connected to a control unit (not shown) provided at the vehicle 1 by means of the signal line 28b and the terminal 28c. The operation lever 28a is operated between an initial position in which the operation lever 28a is separated from the latch 25, and a contact position in which the operation lever 28a is in contact with the latch 25. These two positions correspond to the engaging state of the latch 25 and the striker 4, i.e. the unlatched state and the latched state respectively. The two positions of the operation lever 28a also correspond to the OFF and ON state of the detection switch 28. That is, the detection switch 28 outputs two different types of signal in response to a rotation position of the latch 25, and electrically detects the engaging state of the latch 25 and the striker 4.

As mentioned above, the first end 24a of the supporting shaft 24 is inserted into the through-hole 25b of the latch 25 and the supporting bore 21b of the base 21, and then riveted to the base 21. The riveting of the supporting shaft 24 to the base 21 is explained with reference to FIGS. 7A to 7C.

First, the supporting shaft 24 is placed onto a predetermined riveting jig T. At this time, the second end 24b is supported by the riveting jig T such that the first end 24a of the supporting shaft 24 is positioned above the second end 24b as shown in FIG. 7A. Then, in order for the latch 25 to engage with the flange portion 24f of the supporting shaft 24, the first end 24a of the supporting shaft 24 is inserted into the through-hole 25b of the latch 25 and then the supporting bore 21b of the base 21 as shown in FIG. 7B. Finally, as shown in FIG. 7C, a predetermined riveting load Fc is applied to the first end 24a of the supporting shaft 24 that has been inserted into the supporting bore 21b of the base 21 so that the first end 24a of the supporting shaft 24 is riveted to the base 21. The latch 25 is sandwiched between the flange portion 24f and the base 21 accordingly. The position of the latch 25 in an axial direction of the supporting shaft 24 (i.e. vertical direction in FIG. 7) is retained relative to the base 21. That is, the movement of the latch 25 along the supporting shaft 24 is restricted. According to the above-mentioned structure, when the latch 25 rotates relative to the supporting shaft 24, the latch 25 is prohibited to be loose in the axial direction of the supporting shaft 24, which may achieve a stable rotation of the latch 25.

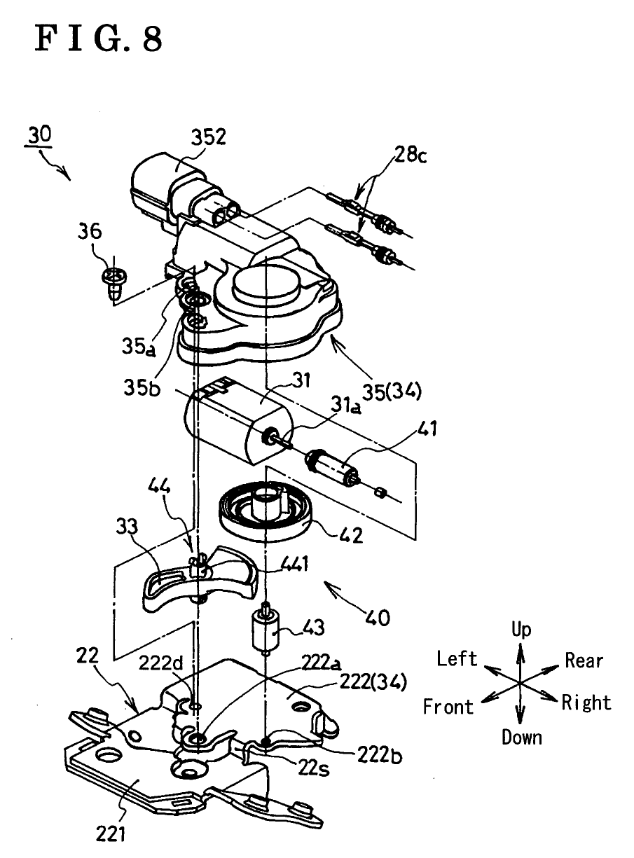

Next, the release mechanism 30 is explained with reference to FIG. 8, which is an exploded perspective view of the release mechanism 30.

The release mechanism 30 brings the engagement between the pawl 26 and the latch 25 (i.e. engagement between the striker 4 and the latch 25) to be released by a driving force of an electric motor 31. The release mechanism 30 serves as an actuator for bringing the driving force of the motor 31 to be output as the lever operation force Fo (see FIG. 6). The release mechanism 30 includes the motor 31, a deceleration mechanism 40 serving as an example of a transmission mechanism, and a housing 34 serving as an example of a case.

The motor 31 has a known structure equipped with a rotation shaft 31a. The motor 31 is connected to a metal terminal (to be mentioned later) through which power is supplied to the motor 31. When the motor 31 is powered, the rotation shaft 31a is rotated to generate the driving force (i.e. torque).

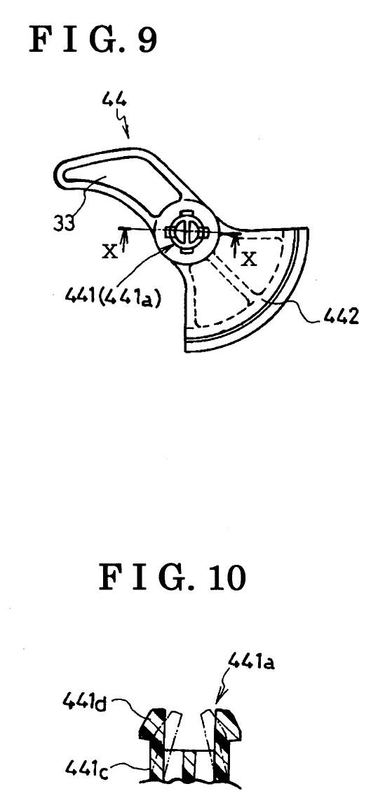

The deceleration mechanism 40 includes a worm 41, a worm wheel 42, a pinion gear 43, and a sector gear 44, by means of which the deceleration mechanism 40 decreases a rotational speed of (i.e. decelerates) the rotation shaft 31a of the motor 31 and increases the driving force generated by the motor 31. The worm 41 and the worm wheel 42 have a known structure. The worm 41 is coaxially secured to the rotation shaft 31a of the motor 31 and engages with the worm wheel 42. The pinion gear 43 is a spur gear having a smaller diameter than that of the worm wheel 42, and is coaxially secured to the worm wheel 42. The pinion gear 43 engages with the sector gear 44. FIG. 9 is a view showing a structure of the sector gear 44. The sector gear 44 consists of a partial circumference. The sector gear 44 includes a supporting shaft 441, a gear portion 442, and a lever portion 33. The supporting shaft 441 constitutes a rotational center of the sector gear 44 and relative to which the sector gear 44 rotates. Engaging portions 441a and 441b are respectively formed on axially both ends of the supporting shaft 441. FIG. 10 is a view showing a structure of the engaging portion 441a (i.e. a cross-sectional view taken along the line X-X of FIG. 9). The engaging portion 441b has a substantially same structure as that of the engaging portion 441a and thus an explanation is omitted. The engaging portion 441a includes a base portion 441c and a hook portion 441d. The base portion 441c is formed, being continued from a main body of the supporting shaft 441. The hook portion 441d is integrally formed on the base portion 441c. The engaging portion 441a has a substantially cantilever shape whose one end is a fixed end while the other end is a free end. The hook portion 441d is elastically deformed between an initial shape (shown by a solid line in FIG. 10) and a deformed shape (shown by a chain double-dashed line in FIG. 10) relative to the base portion 441c. The gear portion 442 of a spur gear is formed in an outer circumferential direction relative to the supporting shaft 441. The gear portion 442 of the sector gear 44 engages with the pinion gear 43. The lever portion 33 of an arm shape is arranged on an opposite side of the gear portion 442 relative to the supporting shaft 441. The lever portion 33 is connected to the lift lever 29 of the lock mechanism 20.

A speed reduction ratio of the deceleration mechanism 40 is determined on the basis of the number of teeth of the worm 41, the worm wheel 42, the pinion gear 43, and the sector gear 44 (i.e. gear portion 442). The driving force generated by the motor 31 is increased on the basis of the speed reduction ratio obtained in the aforementioned manner and finally transmitted to the lever portion 33 of the sector gear 44.

The housing 34 is constituted by the second portion 222 of the sub-base 22 and a cover 35 serving as an example of a third member. The housing 34 accommodates therein the motor 31 and the deceleration mechanism 40. The housing 34 rotatably supports the worm wheel 42 coaxially holding the pinion gear 43, and the sector gear 44 between the sub-base 22 (precisely, the second portion 222) and the cover 35. The sub-base 22 and the cover 35 are connected to each other by means of a screw 36. The screw 36 is inserted into a connecting bore 35a formed on the cover 35 and screwed into a connecting bore 222d formed on the sub-base 22. As shown in FIG. 2, the cover 35 is arranged opposite to the base 21 relative to the sub-base 22. The cover 35 and the base 21 are positioned so as to overlap each other by disposing the sub-base 22 therebetween.

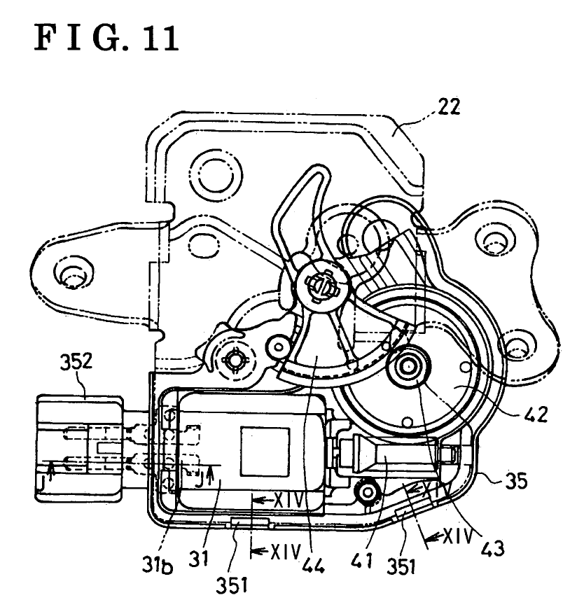

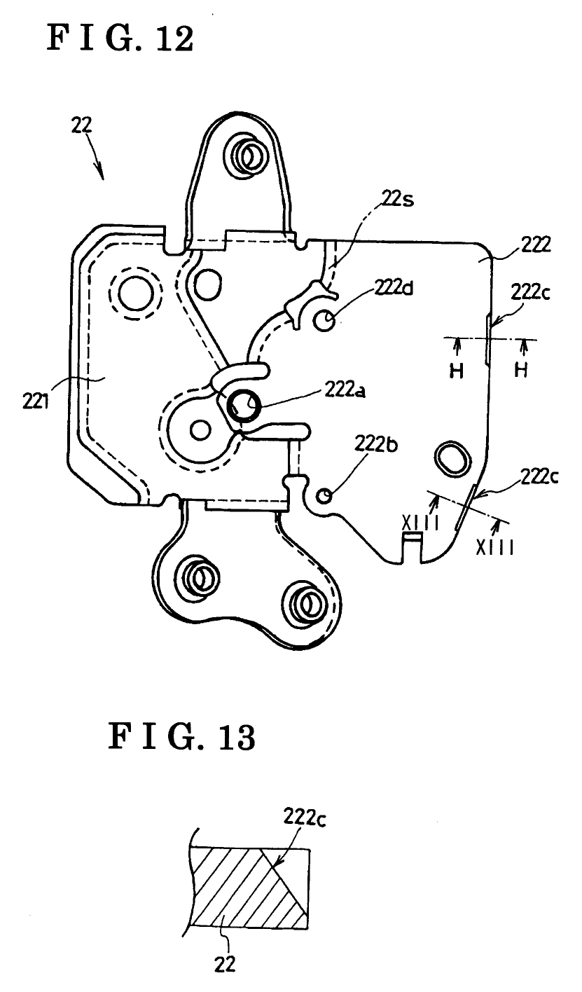

FIG. 11 is a view in the cases where the release mechanism 30 is viewed from a lower side of FIG. 8. FIG. 12 is a view only showing the sub-base 22 as viewed from an upper side of FIG. 8.

The first portion 221 and the second portion 222 are integrally formed through a stepped portion 22s. The first portion 221 constitutes a part of the lock mechanism 20 as mentioned above. The second portion 222 constitutes a part of the housing 34 of the release mechanism 30. That is, the release mechanism 30 and the lock mechanism 20 share the sub-base 22.

The second portion 222 of the sub-base 22 includes a lever supporting bore 222a, a gear supporting bore 222b, and a guide face 222c. The gear supporting bore 222b is formed by penetrating through the second portion 222. The gear supporting bore 222b rotatably supports the worm wheel 42 and the pinion gear 43, which are integrally formed, together with a gear supporting bore (not shown) formed on the cover 35. The lever supporting bore 222a is formed by penetrating through the second portion 222. The lever supporting bore 222a rotatably supports the supporting shaft 441 of the sector gear 44 together with the lever supporting bore 35b formed on the cover 35 (see FIG. 8). As shown in FIG. 11, the worm wheel 42 supported by the gear supporting bore 222b along with the pinion gear 43 is sandwiched between the sector gear 44 and the cover 35. FIG. 13 is a view showing a structure of the guide face 222c (i.e. a cross-sectional view taken along the line XIII-XIII in FIG. 12). The guide face 222c is formed on an edge portion of the second portion 222 of the sub-base 22. Precisely, the guide face 222c is formed by partially cutting (i.e. chamfering) the edge portion of the second portion 222 of the sub-base 22 so as to have a slope shape.

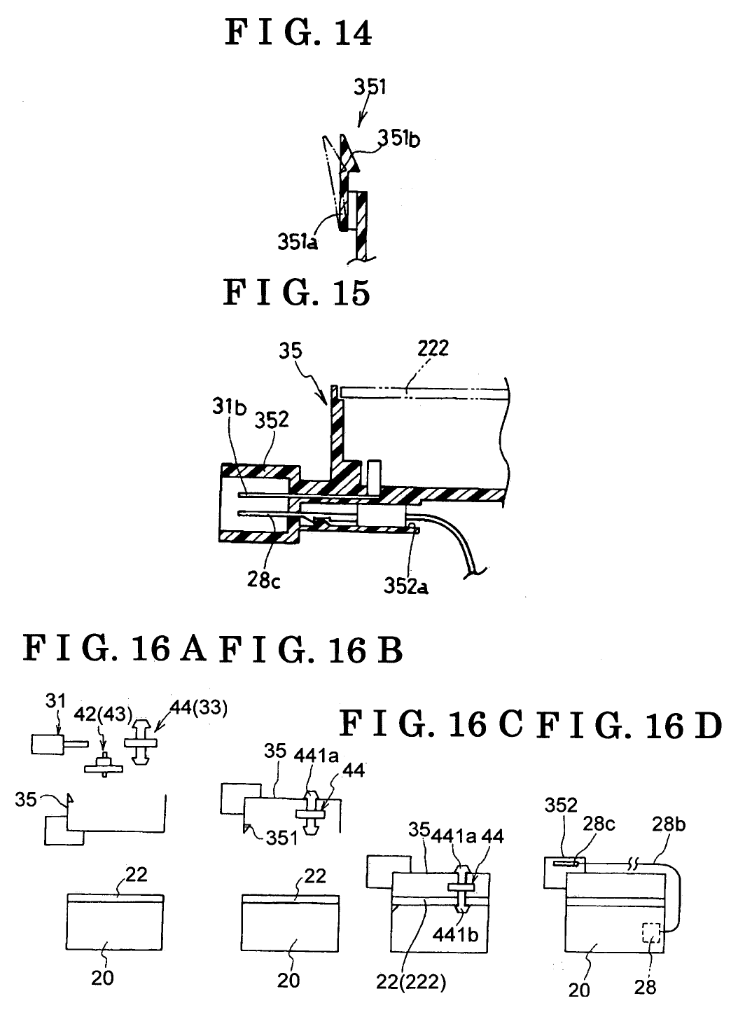

The cover 35 made of resin constitutes the housing 34 together with the sub-base 22. A connecting portion 351 is integrally formed on the cover 35. The connecting portion 351 is closely making contact with the guide face 222c formed on the second portion 222 of the sub-base 22 and then locked relative to the second portion 222 of the sub-base 22. FIG. 14 is a view showing a structure of the connecting portion 351 (i.e. a cross-sectional view taken along the line XIV-XIV in FIG. 11). The connecting portion 351 includes a base portion 351a and a hook portion 351b. The base portion 351a forming an edge of the cover 35 is integrally connected to the cover 35. The connecting portion 351 is integrally formed on the base portion 351a. The hook portion 351b has a substantially cantilever shape whose one end is a fixed end while the other end is a free end. The hook portion 351b is elastically deformed between an initial shape (shown by a solid line in FIG. 14) and a deformed shape (shown by a chain double-dotted line in FIG. 14) relative to the base portion 351a.

Further, a connector 352 is integrally formed on the cover 35. FIG. 15 is a view showing a structure of the connector 352. The connector 352 retains a terminal 31b connected to the motor 31 and a terminal 28c (see also FIG. 5) of the signal line 28b led from the detection switch 28 of the lock mechanism 20. The terminal 31b for the motor 31 is molded with the connector 352 (i.e. cover 35) beforehand (i.e. resin insert molding) and then fit to a connecting portion (not shown) formed on the motor 31. The terminal 28c for the detection switch 28 is fit to a fitting bore 352a formed on the connector 352. The terminal 28c is independently fit to the connector 352 equipped with the terminal 31b as a unit. The control unit (not shown) formed on the vehicle 1 is connected to the connector 352 retaining the terminal 31b for the motor 31 and the terminal 28c for the detection switch 28. The control unit supplies power to the motor 31 and receives an output signal from the detection switch 28.

Next, an assembly of the door lock device 10 is explained with reference to FIGS. 16A to 16D, which show a series of assembly operations of the door lock device 10.

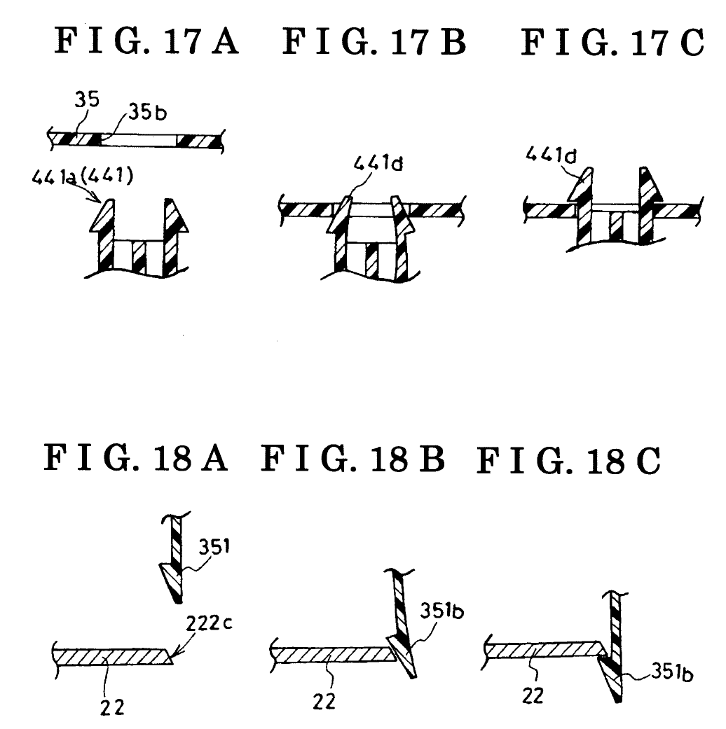

As shown in FIG. 16A, the lock mechanism 20 including the base 21, the sub-base 22, and the like is assembled. At the same time, the motor 31 retaining the worm 41, the worm wheel 42 and the pinion gear 43 united with each other, and the sector gear 44 formed with the lever portion 33 as a unit are assembled in this order on the cover 35 that partially forms the housing 34 of the release mechanism 30. At this time, the motor 31 is connected to the terminal 31b (see FIG. 15) by press fitting, the terminal 31b being integrally formed on the cover 35 beforehand. The engaging portion 441a of the supporting shaft 441 of the sector gear 44 is connected to the lever supporting bore 35b formed on the cover 35. The method of connecting the engaging portion 441a of the sector gear 44 to the lever supporting bore 35b of the cover 35 is explained with reference to FIGS. 17A to 17C.

First, as shown in FIG. 17A, the lever supporting bore 35b of the cover 35 and the engaging portion 441a of the sector gear 44 are aligned in terms of an axial direction of the supporting shaft 441 of the sector gear 44 (i.e. vertical direction in FIG. 17A). Then, the sector gear 44 is moved towards the cover 35 so that the engaging portion 441a is fitted to the lever supporting bore 35b. At this time, the hook portion 441d of the engaging portion 441a is elastically deformed and fitted to the lever supporting bore 35b as shown in FIG. 17B. When the sector gear 44 is further moved towards the cover 35, the elastically deformed hook portion 441d of the engaging portion 441a penetrates through the lever supporting bore 35b and then returned to the initial shape from the deformed shape as shown in FIG. 17C. Accordingly, the engaging portion 441a is locked into the lever supporting bore 35b in terms of the axial direction of the supporting shaft 441. That is, the sector gear 44 including the lever portion 33 as a unit is retained by the cover 35.

At a time of the sector gear 44 locked relative to the cover 35, the worm wheel 42 and the pinion gear 43 united with each other are disposed between the sector gear 44 and the cover 35. In addition, the motor 31 connected to the worm wheel 42 through the worm 41 is retained by the cover 35 by means of the terminal 31b integrally formed on the cover 35. That is, at a time of the sector gear 44 being locked relative to the cover 35, the cover 35 is united with the motor 31 of which is retaining the worm 41, the worm wheel 42 and the pinion gear 43 that are united with each other, and the sector gear 44 integrally including the lever portion 33. According to such a structure, these components are prevented from falling from the cover 35 in an assembly process afterwards, which leads to no means required for retaining these components at the cover 35. Thus, the efficient assembly operation of the door lock device 10 can be achieved. Next, as shown in FIGS. 16B and 16C, while a position of the cover 35 retaining the motor 31, the sector gear 44, and the like are reversed, the connecting portion 351 of the cover 35 and the engaging portion 441b (see FIG. 8) of the sector gear 44 are respectively connected to the sub-base 22 (precisely, second portion 222) of the lock mechanism 20 that has been assembled beforehand. The method of connecting the connecting portion 351 of the cover 35 to the sub-base 22 of the lock mechanism 20 is explained with reference to FIGS. 18A to 18C.

First, the connecting portion 351 of the cover 35 and the guide face 222c of the sub-base 22 are aligned in terms of the vertical direction as shown in FIG. 18A. Then, the cover 35 is moved towards the sub-base 22 so that the connecting portion 351 of the cover 35 can closely make contact with the guide face 222c. At this time, the hook portion 351b of the connecting portion 351 is guided to the guide face 222c while being elastically deformed as shown in FIG. 18B. When the cover 35 is further moved towards the sub-base 22, the elastically deformed hook portion 351b of the connecting portion 351 climbs over the guide face 222c to thereby cause the hook portion 351b to return from a deformed shape to an initial shape as shown in FIG. 18C. Accordingly, the hook portion 351b of the connecting portion 351 is locked relative to the sub-base 22. That is, the cover 35 equipped with the connecting portion 351 is retained by the second portion 222 of the sub-base 22.

While the connecting portion 351 of the cover 35 is connected to the sub-base 22 of the lock mechanism 20, the engaging portion 441b of the sector gear 44 retained by the cover 35 is connected to the lever supporting bore 222a of the sub-base 22. The method of connecting the engaging portion 441b of the sector gear 44 to the sub-base 22 is same as that shown in FIGS. 17A to 17C and thus the explanation is omitted.

After the connecting portion 351 of the cover 35 and the engaging portion 441b of the sector gear 44 are respectively connected to the sub-base 22, the cover 35 and the sub-base 22 are further connected to each other using the screw 36 (see FIG. 8).

The connection between the cover 35 and the sub-base 22 are performed by: 1. engagement between the connecting portion 351 of the cover 35 and the sub-base 22, 2. engagement between the engaging portion 441a of the sector gear 44 and the cover 35, 3. engagement between the engaging portion 441b of the sector gear 44 and the sub-base 22, and 4. engagement between the cover 35 and the sub-base 22 by means of the screw 36. According to such the structure, if sufficient connecting strength is ensured by the above methods 1 through 3, the method 4 using the screw 36 is not necessarily adopted.

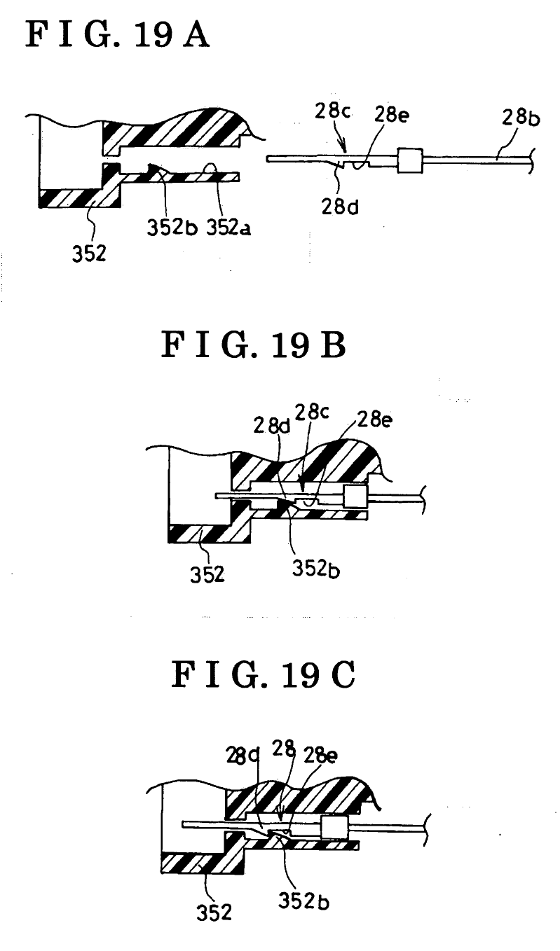

After the cover 35 and the sub-base 22 are connected to each other in the aforementioned manner, the terminal 28c of the signal line 28b of the detection switch 28 led out from the lock mechanism 20 is fitted to the connector 352 of the cover 35. The method of fitting the terminal 28c of the detection switch 28 to the connector 352 of the cover 35 is explained with reference to FIGS. 19A to 19C.

First, the terminal 28c of the signal line 28b and the fitting bore 352a of the connector 352 are aligned in terms of an axial direction of the fitting bore 352a (i.e. horizontal direction in FIG. 19A) as shown in FIG. 19A. Then, the terminal 28c of the signal line 28b is moved towards the connector 352 so that an inclined guide portion 28d formed on the terminal 28c is made contact with a hook portion 352b formed on the fitting bore 352a of the connector 352 as shown in FIG. 19B. When the terminal 28c is further moved towards the connector 352, the guide portion 28d of the terminal 28c climbs over the hook portion 352b of the fitting bore 352a, which causes the hook portion 352b of the fitting bore 352a to be locked into a concave portion 28e continuously formed on the guide portion 28d. Therefore, the terminal 28c of the signal line 28b fitted to the fitting bore 352a is surely retained by the connector 352 of the cover 35 as shown in FIG. 19C. According to the manner shown in FIGS. 16A to 16D, the assembly operation of the door lock device 10 including the lock mechanism 20 and the release mechanism 30 is completed.

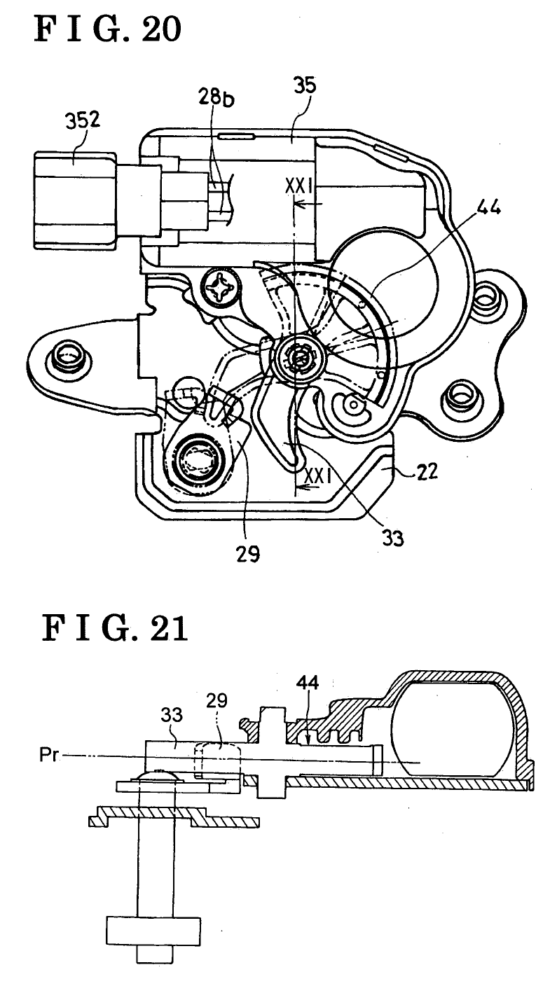

An operation of the door lock device 10 in the closed state of the door 2 is explained with reference to FIGS. 6, 8, and 20. FIG. 20 is a view showing an operation of the sector gear 44 and the lift lever 29 in the cases where the door lock device 10 is activated (i.e. an arrow view in C direction in FIG. 3).

In FIG. 20, when the motor 31 of the release mechanism 30 is powered, the driving force is generated by the motor 31. The driving force generated is transmitted to the sector gear 44 through the worm 41, the worm wheel 42, and the pinion gear 43. Then, the sector gear 44 rotates in the clockwise direction in FIG. 20 relative to the supporting shaft 441, which causes the lever portion 33 integrally formed on the sector gear 44 to operate from an initial position (shown by a solid line in FIG. 20) to a stroke position (shown by a chain double-dashed line in FIG. 20). At this time, the lift lever 29 secured to the pawl 26 of the lock mechanism 20 engages with the lever portion 33 that is moving to the stroke position from the initial position, and receives a force (that corresponds to the lever operation force Fo in FIG. 6) from the lever portion 33. The lift lever 29 receiving the force from the lever portion 33 rotates in the counterclockwise direction in FIG. 20 so as to move from an initial position to a stroke position. As mentioned above, the lift lever 29 is secured to the pawl 26 of the lock mechanism 20. Thus, when the lift lever 29 rotates by receiving the force from the lever portion 33, the pawl 26 also rotates as a unit with the lift lever 29. The engagement between the pawl 26 and the latch 25 is then released, thereby causing the door 2 to shift to the closed state to be opened.

FIG. 21 is a view showing a positional relationship between the sector gear 44 and the lift lever 29 (i.e. cross-sectional view taken along the line XXI-XXI in FIG. 20). As shown in FIG. 21, according to the door lock device 10 of the present embodiment, the lever portion 33 is positioned on a plane Pr that includes a rotational locus of the sector gear 44. The lever portion 33 pushes the lift lever 29 on the plane Pr. According to such the structure, a dimension of the lever portion 33 of the release mechanism 30 and the lift lever 29 of the lock mechanism in terms of a vertical direction of the door lock device 10 (i.e. vertical direction in FIG. 21), i.e. a dimension of driving force transmittal portion of the door lock device 10, can be reduced.

According to the aforementioned embodiment, the cover 35 includes the connecting portion 351 through which the cover 35 and the sub-base 22 are connected to each other. However, the embodiment is not limited to the above structure. For example, a mechanism corresponding to the connecting portion 351 can be formed on the sub-base 22. In this case, a structure corresponding to the guide face 222c that is originally formed on the sub-base 22 may be formed on the cover 35 so as to engage with the connecting portion 351.

As explained above, according to the door lock device 10 of the present embodiment, the sub-base 22 partially forms the lock mechanism 20 that includes the latch 25 and the lift lever 29 (with the pawl 26) and also partially forms the release mechanism 30 that includes the motor 31 and the deceleration mechanism 40. That is, the lock mechanism 20 and the release mechanism 30 are arranged adjacent to each other through the sub-base 22. Thus, a member for connecting the lock mechanism 20 and the release mechanism 30 is not required, thereby reducing the number of components in the door lock device 10 and improving efficiency of space. Therefore, a downsizing of the door lock device 10 can be realized and space required for installing the door lock device 10 can be reduced.

Further, according to the present embodiment, the base 21 for the lock mechanism 20 and the cover 35 for the release mechanism 30 are arranged so as to overlap each other by means of the sub-base 22. In such the structure, since the lock mechanism 20 is closely arranged to the release mechanism 30, space efficiency in the door lock device 10 can be further improved, which may contribute further downsizing of the door lock device 10. As a result, space required for installing the door lock device 10 can be further reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door lock device for a vehicle comprising:
a striker formed on either a vehicle body or a door;
a first member including a groove portion for receiving the striker and being formed on either the door or the vehicle body;
a latch engaging with the striker so as to retain the door relative to the vehicle body and being rotatably supported by the first member;
a release member operated so as to release an engagement between the latch and the striker;
a second member connected to the first member for holding the latch and the release member;
a motor for generating a driving force so as to operate the release member;
a transmission mechanism for transmitting the driving force generated by the motor to the release member; and
a case for receiving the motor and the transmission mechanism; the case including the second member and a third member connected to the second member and accommodating therein the motor and the transmission mechanism, the second member being sandwiched between the first member and the third member.

2. A door lock device for a vehicle according to claim 1, wherein the first member and the third member are arranged so as to overlap each other by means of the second member.

3. A door lock device for a vehicle according to claim 1, wherein the second member includes a first portion connected to the first member and a second portion connected to the third member.

4. A door lock device for a vehicle according to claim 3, wherein the first member and the first portion of the second member partially constitute a housing for a lock mechanism, and the third member and the second portion of the second member partially constitute a housing for a release mechanism.

5. A door lock device for a vehicle according to claim 4, wherein the lock mechanism and the release mechanism share the second member.

6. A door lock device for a vehicle according to claim 1, wherein the first member and the third member are arranged so as to overlap each other by means of the second member.

7. A door lock device for a vehicle according to claim 3, wherein the first member and the third member are arranged so as to overlap each other by means of the second member.

8. A door lock device for a vehicle according to claim 4, wherein the first member and the third member are arranged so as to overlap each other by means of the second member.

9. A door lock device for a vehicle according to claim 3, wherein the second portion of the second member includes a gear supporting bore for rotatably supporting a worm wheel and a pinion gear, a lever supporting bore for rotatably supporting a sector gear, and a guide face formed on an edge portion of the second portion.
